(19) United States
(12) Patent Application Publication
(10) Pub. No.: US 2023/0129074 A1
(43) Pub. Date: Apr. 27, 2023

(54) DRIVING ASSISTANCE DEVICE, DRIVING ASSISTANCE SYSTEM, AND RECORDING MEDIUM

(71) Applicant: TOYOTA JIDOSHA KABUSHIKI KAISHA, Toyota-shi (JP)

(72) Inventors: Kazuhiro ITOU, Toyota-shi (JP); Daisuke TSUCHIYA, Numazu-shi (JP)

(73) Assignee: TOYOTA JIDOSHA KABUSHIKI KAISHA, Toyota-shi (JP)

(21) Appl. No.: 17/895,526

(22) Filed: Aug. 25, 2022

(30) Foreign Application Priority Data
Oct. 22, 2021 (JP) 2021-173403

(51) Int. Cl. B62D 15/02; G06F 3/01; G01C 21/36

(52) U.S. Cl. CPC B62D 15/029; G06F 3/013; G01C 21/3632

(57) ABSTRACT

A driving assistance device includes: a processor configured to acquire moving body information indicating information of a moving body, and corner information indicating information of a corner of a road where the moving body travels, and output assistance information that assists traveling of the moving body by controlling a light emission mode of a display unit located in a steering direction at the corner on a basis of the moving body information and the corner information.

### CROSS-REFERENCE TO RELATED APPLICATION(S)

The present application claims priority to and incorporates by reference the entire contents of Japanese Patent Application No. 2021-173403 filed in Japan on Oct. 22, 2021.

### BACKGROUND

The present disclosure relates to a driving assistance device, a driving assistance system, and a recording medium.

Japanese Laid-open Patent publication No. 2002-160596 discloses a driving assistance device that assists driving by issuing a warning to a driver of a vehicle. Japanese Laid-open Patent publication No. 2006-047198 discloses a technique of displaying a shape of a corner.

There has been a demand for a technique of improving operability of a moving body such as a vehicle.

There is a demand for providing a driving assistance device, driving assistance system, and a recording medium capable of improving the operability of a moving body.

According to an embodiment, a driving assistance device includes: a processor configured to acquire moving body information indicating information of a moving body, and corner information indicating information of a corner of a road where the moving body travels, and output assistance information that assists traveling of the moving body by controlling a light emission mode of a display unit located in a steering direction at the corner on a basis of the moving body information and the corner information.

According to an embodiment, a driving assistance system includes: display units that are arranged on right and left sides and that display assistance information to assist traveling of a moving body at a corner of a road; and a processor configured to acquire moving body information indicating information of the moving body and corner information indicating information of the corner, and output the assistance information, which controls a light emission mode of the display unit located in a steering direction at the corner, to the display unit on a basis of the moving body information and the corner information.

According to an embodiment, a non-transitory computer-readable recording medium storing a program for causing a processor to execute: acquiring moving body information indicating information of a moving body and corner information indicating information of a corner of a road where the moving body travels; and outputting assistance information that assists traveling of the moving body by controlling a light emission mode of a display unit located in a steering direction at the corner on a basis of the moving body information and the corner information.

### BRIEF DESCRIPTION OF THE DRAWINGS

FIG. 1 is a block diagram illustrating a functional configuration of a driving assistance device according to a first embodiment;

FIG. 2 is a view illustrating a schematic configuration of a display unit;

FIG. 3 is a view illustrating the schematic configuration of the display unit;

FIG. 4 is a flowchart illustrating processing executed by the driving assistance device;

FIG. 5 is a view illustrating lighting timing of the display unit;

FIG. 6 is a view illustrating lighting timing of the display unit;

FIG. 7 is a view illustrating lighting timing of the display unit;

FIG. 8 is a view illustrating a schematic configuration of a display unit of a second modification example;

FIG. 9 is a view illustrating a schematic configuration of a display unit of a third modification example;

FIG. 10 is a view illustrating a schematic configuration of a display unit of a fourth modification example;

FIG. 11 is a view illustrating a schematic configuration of a display unit of a fifth modification example; and

FIG. 12 is a view illustrating a schematic configuration of a display unit of a sixth modification example.

### DETAILED DESCRIPTION

A driving assistance device, a driving assistance system, and a recording medium according to an embodiment of the present disclosure will be described with reference to the drawings. Note that components in the following first embodiment include what can be easily replaced by those skilled in the art or what is substantially the same.

### First Embodiment

Configuration of Driving Assistance Device

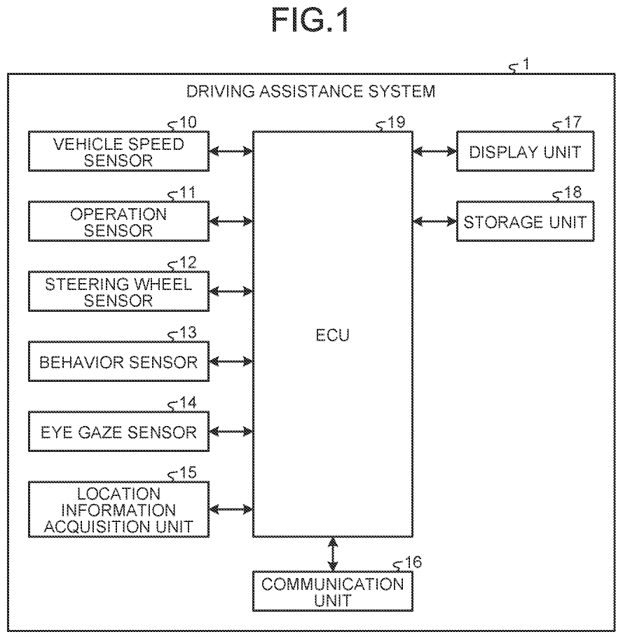

FIG. 1 is a block diagram illustrating a functional configuration of a driving assistance device according to the first embodiment. A driving assistance system 1 illustrated in FIG. 1 is mounted on a moving body such as a vehicle and assists driving, which is performed by a driver in the vehicle, in cooperation with another electronic control unit (ECU) mounted on this vehicle. However, the driving assistance system 1 only needs to be mounted on a moving body, and may be mounted on a two-wheeled vehicle or the like. Furthermore, the driving assistance system 1 may assist driving performed by a driver of a moving body in a virtual space, such as a drive simulator.

The driving assistance system 1 illustrated in FIG. 1 includes a vehicle speed sensor 10, an operation sensor 11, a steering wheel sensor 12, a behavior sensor 13, an eye gaze sensor 14, a location information acquisition unit 15, a communication unit 16, a display unit 17, a storage unit 18, and an ECU 19 as a driving assistance device.

The vehicle speed sensor 10 detects a vehicle speed during traveling of the vehicle, and outputs a detection result thereof to the ECU 19.

The operation sensor 11 detects an operation amount indicating a pedaling amount of each of an accelerator pedal, a brake pedal, and a clutch pedal by the driver, and outputs a detection result thereof to the ECU 19.

The steering wheel sensor 12 detects a steering amount of a steering wheel by the driver, and outputs a detection result thereof to the ECU 19.

The behavior sensor 13 detects a behavior of the vehicle, and outputs a detection result thereof to the ECU 19. Here, the behavior of the vehicle includes a pitch rate, a roll rate, a yaw rate, vertical acceleration, lateral acceleration, longitudinal acceleration, and the like. The behavior sensor 13 includes an acceleration sensor, a gyroscope sensor, and the like.

The eye gaze sensor 14 detects an eye gaze of the driver seated on a driver seat of the vehicle, and acquires eye gaze information. Then, the eye gaze sensor 14 outputs the eye gaze information to the ECU 19. The eye gaze sensor 14 includes an optical system, a charge coupled device (CCD) or a complementary metal oxide semiconductor (CMOS), a memory, and a processor having hardware, such as a central processing unit (CPU) or a graphics processing unit (GPU). The eye gaze sensor 14 detects a non-moving portion of an eye (such as inner corner of the eye) of the driver as a reference point by using, for example, known template matching, detects a moving portion of the eye (such as iris) as a moving point, and detects the eye gaze of the driver on the basis of a positional relationship between the reference point and the moving point. Note that the eye gaze sensor 14 detects the eye gaze of the driver by, for example, a visible camera. However, this is not a limitation, and the eye gaze of the driver may be detected by an infrared camera. In a case where the eye gaze sensor 14 includes the infrared camera, a reference point (such as corneal reflex) and a moving point (such as pupil) are detected from image data generated by emission of infrared light to the driver by an infrared light emitting diode (LED) or the like and imaging of the driver with the infrared camera, and the eye gaze of the driver is detected on the basis of a positional relationship between the reference point and the moving point.

The location information acquisition unit 15 acquires current location information of the vehicle. This location information acquisition unit 15 acquires the location information by using, for example, a satellite positioning device such as a GPS device. That is, the location information acquisition unit 15 can acquire the current location information of the vehicle by using a global navigation satellite system (GNSS) positioning system.

Under the control of the ECU 19, the communication unit 16 transmits various kinds of information to a server (not illustrated) via a base station and a network in accordance with a predetermined communications standard, and receives various kinds of information from the server. The communication unit 16 includes a communication module capable of wireless communication. Furthermore, the communication unit 16 may be wired or wireless.

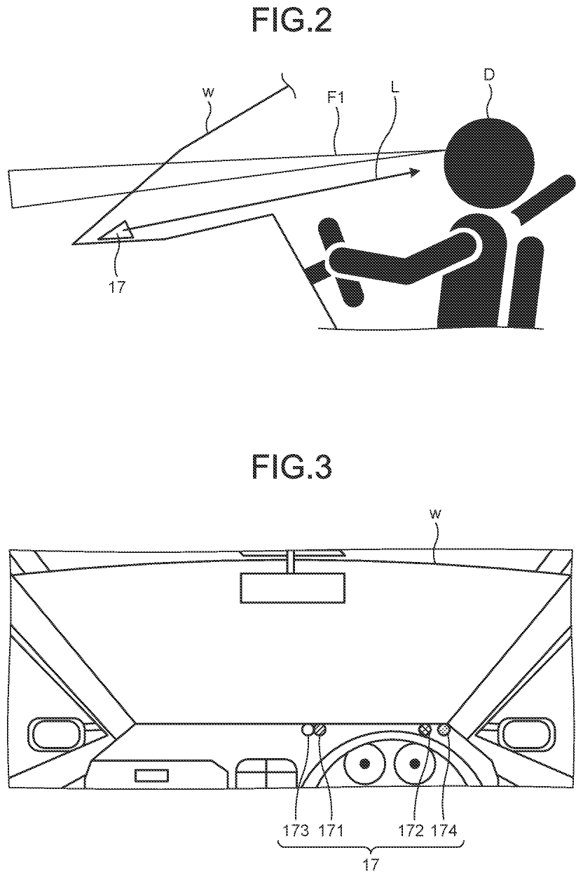

The display unit 17 includes a highly visible light source including a light emitting diode (LED) or the like. FIG. 2 is a view illustrating a schematic configuration of the display unit. As illustrated in FIG. 2, the display unit 17 is arranged, for example, between a windshield W and a dashboard of the vehicle, and a light emitting direction thereof is a direction different from a direction of an eye gaze F1 of a driver D of the vehicle (arrow L1). The display unit 17 may be capable of changing the light emitting direction, and may change a position, to which light is emitted, according to the eye gaze information detected by the eye gaze sensor 14.

FIG. 3 is a view illustrating the schematic configuration of the display unit. As illustrated in FIG. 3, the display unit 17 includes two LEDs 171 and 172 arranged on the right and left, and two blind spot monitor (BSM) lamps 173 and 174 arranged outside the LEDs 171 and 172. The display unit 17 displays characteristic information indicating a characteristic of a corner by causing the LEDs 171 and 172 and the BSM lamps 173 and 174 to emit light in different colors, to light at different frequencies, or to light for different lengths. The characteristic information indicates, for example, a direction of a corner (right or left), a radius of curvature of the corner, a depth of the corner, or the like.

The storage unit 18 includes recording media such as an erasable programmable ROM (EPROM), a hard disk drive (HDD), and a removable medium. Examples of the removable medium include recording media such as an optical disk (such as compact disc (CD)-R, CD-ROM, digital versatile disc (DVD)-R, DVD-ROM, or Blu-ray (registered trademark) disc (BD)), and a flash memory (such as universal serial bus (USB) memory or memory card). The storage unit 18 can store an operating system (OS), various programs, various tables, various databases, and the like. In addition, the storage unit 18 stores various kinds of information acquired by the vehicle speed sensor 10, the operation sensor 11, the steering wheel sensor 12, the behavior sensor 13, the eye gaze sensor 14, and the location information acquisition unit 15, and various kinds of information received by the communication unit 16.

The ECU 19 controls an operation of each unit included in the driving assistance system 1. The ECU 19 includes a memory, and any of processors having hardware, such as a CPU, a graphics processing unit (GPU), a field programmable gate array (FPGA), digital signal processing (DSP), and an application specific integrated circuit (ASIC). The ECU 19 acquires vehicle information indicating information of the vehicle and corner information indicating information on a corner of a road where the vehicle travels, and outputs, to the display unit 17, assistance information to assist traveling of the vehicle by controlling a light emission mode of the display unit 17, which is located in a steering direction at the corner, on the basis of the vehicle information and the corner information.

The vehicle information includes, for example, various kinds of information acquired by the vehicle speed sensor 10, the operation sensor 11, the steering wheel sensor 12, and the behavior sensor 13, such as a vehicle speed.

The corner information includes, for example, map information acquired by the communication unit 16 from the server, and the location information of the vehicle which information is acquired by the location information acquisition unit 15. The ECU 19 specifies a corner where the vehicle travels from the map information on the basis of the location information, calculates a steering angle required when the vehicle travels at the corner from the map information, and outputs assistance information that varies depending on the steering angle to the display unit. The assistance information is information related to light output from the display unit 17 to the driver of the vehicle, and is, for example, information related to the light emission mode according to the vehicle information and the corner information. The light emission mode indicates a color, emission frequency, or emission time of the light emitted by the LEDs 171 and 172 of the display unit 17. Furthermore, the assistance information may include the light emitting direction of the display unit 17. However, the corner information may include an image captured by an in-vehicle camera. In this case, the ECU 19 calculates characteristic information of the corner by analyzing this image.

Processing of Driving Assistance Device

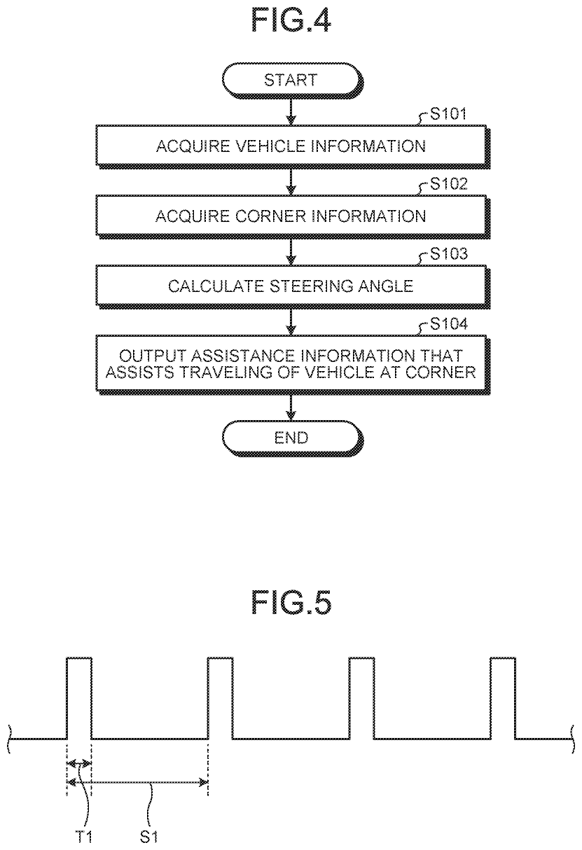

Next, processing executed by the driving assistance system 1 will be described. FIG. 4 is a flowchart illustrating the processing executed by the driving assistance device.

As illustrated in FIG. 4, first, the ECU 19 acquires the vehicle information indicating various kinds of information of the vehicle from the vehicle speed sensor 10, the operation sensor 11, the steering wheel sensor 12, and the behavior sensor 13 (Step S101). Specifically, the ECU 19 acquires vehicle speed information indicating a vehicle speed from the vehicle speed sensor 10, operation information indicating an operation amount from the operation sensor 11, steering information indicating a steering amount from the steering wheel sensor 12, and behavior information indicating a behavior of the vehicle from the behavior sensor 13.

Subsequently, the ECU 19 acquires the corner information indicating information of the corner where the vehicle travels (Step S102). Specifically, the ECU 19 acquires the map information acquired by the communication unit 16 from the server, and the location information of the vehicle which information is acquired by the location information acquisition unit 15.

Subsequently, the ECU 19 calculates a steering angle required when the vehicle travels at the corner (Step S103). First, the ECU 19 specifies a current location of the vehicle in the map information on the basis of the location information, and specifies the corner where the vehicle travels from the map information. Subsequently, the ECU 19 calculates the steering angle required when the vehicle travels at the corner from the map information. Note that the ECU 19 may calculate the steering angle in consideration of the vehicle information such as the vehicle speed.

Then, the ECU 19 outputs, to the display unit 17, the assistance information that assists traveling of the vehicle by controlling the light emission mode of the display unit 17 located in the steering direction at the corner according to the steering angle (Step S104). Specifically, in a case where it is required to steer the steering wheel counterclockwise, the ECU 19 lights the LED 171 located on a left side that is the steering direction. On the other hand, in a case where it is required to steer the steering wheel clockwise, the ECU 19 lights the LED 172 located on a right side that is the steering direction. In addition, the ECU 19 outputs assistance information that calls more attention of the driver of the vehicle as the steering angle becomes larger. Specifically, the ECU 19 changes the color of the LED 171 or the LED 172 in order of green, yellow, orange, and red as the required steering angle becomes larger. Note that the BSM lamp 173 or the BSM lamp 174 may be lit similarly to the LED 171 or the LED 172. Furthermore, the BSM lamp 173 or the BSM lamp 174 may be used instead of the LED 171 or the LED 172.

According to the first embodiment described above, since the ECU 19 controls the light emission mode of the display unit 17 located in the steering direction at the corner and outputs the assistance information to assist the traveling of the vehicle to the display unit 17, operability of the moving body can be improved. Specifically, even in a case where visibility of a corner is poor due to nighttime, fog, rain, snow, or the like, or even in a case where traveling on a road is performed for the first time and it is difficult for a driver to predict a situation of a corner, the ECU 19 outputs assistance information to assist traveling of the vehicle at the corner to the display unit 17. Thus, safe driving can be performed.

### First Modification Example

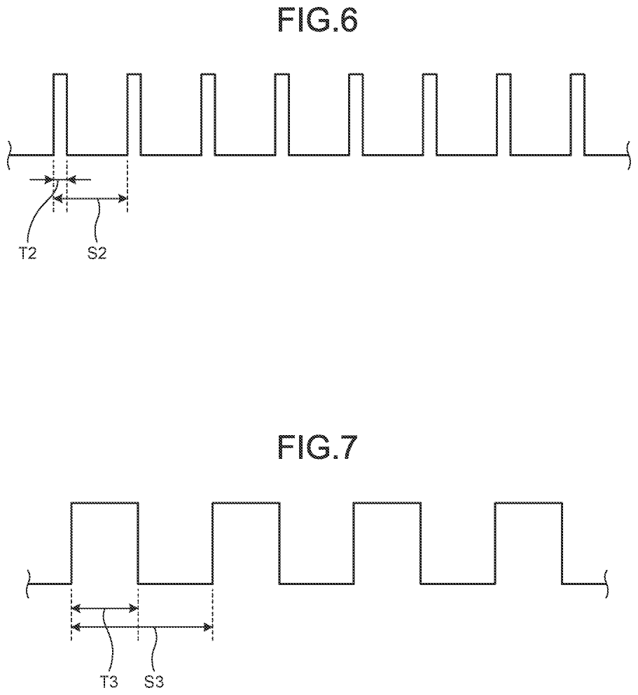

FIG. 5 to FIG. 7 are views illustrating lighting timing of a display unit. FIG. 5 is a view illustrating an example of lighting timing of a display unit 17 of a case where a steering angle calculated by an ECU 19 is equal to or smaller than a threshold, and FIG. 6 is a view illustrating an example of the lighting timing of the display unit 17 of a case where the steering angle is larger than the threshold. As illustrated in FIG. 5 and FIG. 6, lighting time T2 is shorter than lighting time T1, and a lighting cycle S2 is shorter than a lighting cycle S1. In such a manner, the ECU 19 may notify a driver that a required steering angle is large by a frequency of lighting of the display unit 17, and assist traveling of a vehicle at a corner.

FIG. 7 is a view illustrating another example of the lighting timing of the display unit 17 of a case where the steering angle is larger than the threshold. As illustrated in FIG. 5 and FIG. 7, lighting time T3 is longer than the lighting time T1, and the lighting cycle S1 is equal to a lighting cycle S3. In such a manner, the ECU 19 may notify the driver that the required steering angle is large by a length of lighting of the display unit 17, and assist the traveling of the vehicle at the corner.

### Second Modification Example

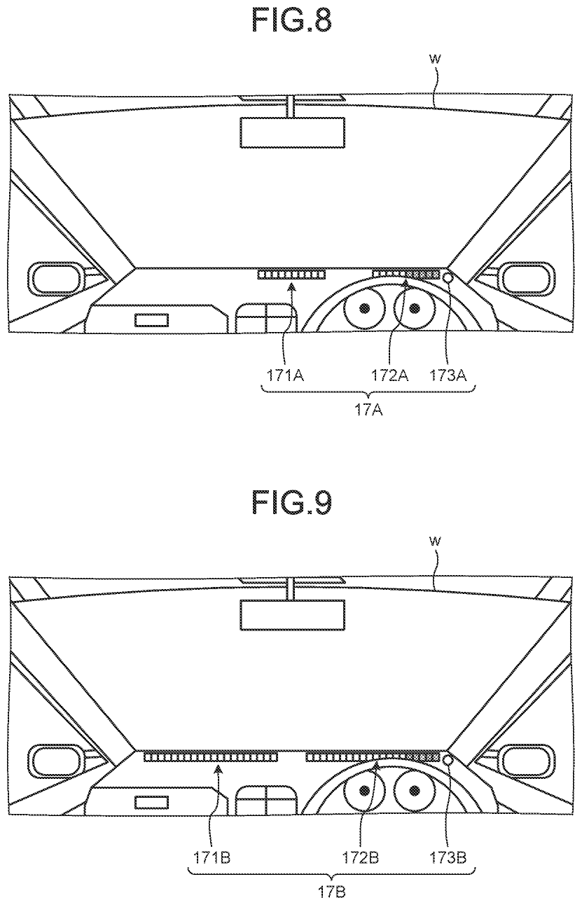

FIG. 8 is a view illustrating a schematic configuration of a display unit of the second modification example. As illustrated in FIG. 8, a display unit 17A includes two LED tapes 171A and 172A arranged on the right and left, and a BSM lamp 173A arranged outside the LED tape 172A. The display unit 17A indicates a direction of a corner (right or left), a radius of curvature of the corner, a depth of the corner, or the like by causing the LED tapes 171A and 172A to emit light in different colors, to light at different frequencies, or to light for different lengths. In addition, the display unit 17A may indicate the radius of curvature of the corner or the depth of the corner by a length of the LED tape 171A or 172A that emits light (four LEDs from a right side of the LED tape 172A emit light in FIG. 8). Specifically, as the radius of curvature of the corner or the depth of the corner becomes larger, the length of the LED tape 171A or 172A to emit light is made longer. Furthermore, the display unit 17A may indicate the radius of curvature of the corner or the depth of the corner by a speed at which the light emission from the LED tape 171A or 172A moves from the inside to the outside. Specifically, the speed at which the light emission from the LED tape 171A or 172A moves from the inside to the outside increases as the radius of curvature of the corner or the depth of the corner increases.

### Third Modification Example

FIG. 9 is a view illustrating a schematic configuration of a display unit of the third modification example. As illustrated in FIG. 9, a display unit 17B includes two LED tapes 171B and 172B arranged on the right and left from both ends toward a center of a vehicle, and a BSM lamp 173B arranged outside the LED tape 172B. The display unit 17B indicates a direction of a corner (right or left), a radius of curvature of the corner, a depth of the corner, or the like by causing the LED tapes 171B and 172B to emit light in different colors, to light at different frequencies, or to light for different lengths. In addition, the display unit 17B may indicate the radius of curvature of the corner or the depth of the corner by a length of the LED tape 171B or 172B that emits light (four LEDs from a right side of the LED tape 172B emit light in FIG. 9). Specifically, as the radius of curvature of the corner or the depth of the corner becomes larger, the length of the LED tape 171B or 172B to emit light is made longer. Furthermore, the display unit 17B may indicate the radius of curvature of the corner or the depth of the corner by a speed at which the light emission from the LED tape 171B or 172B moves from the inside to the outside. Specifically, the speed at which the light emission from the LED tape 171B or 172B moves from the inside to the outside increases as the radius of curvature of the corner or the depth of the corner increases.

### Fourth Modification Example

FIG. 10 is a view illustrating a schematic configuration of a display unit of the fourth modification example. As illustrated in FIG. 10, in a case where a moving body is a two-wheeled vehicle, a display unit 17C-1 is arranged on an upper portion of a shield of a helmet, and emits light in a direction different from an eye gaze F2 of a driver of the two-wheeled vehicle. As in the first embodiment, the display unit 17C-1 has two LEDs arranged on the right and left, and indicates a direction of a corner (right or left), a radius of curvature of the corner, a depth of the corner, or the like by causing the two LEDs to emit light in different colors, to light at different frequencies, or to light for different lengths. In addition, a display unit 17C-2 arranged on a lower portion of the shield of the helmet, or display units 17C-3 arranged on the right and left of the shield of the helmet may be included instead of the display unit 17C-1.

### Fifth Modification Example

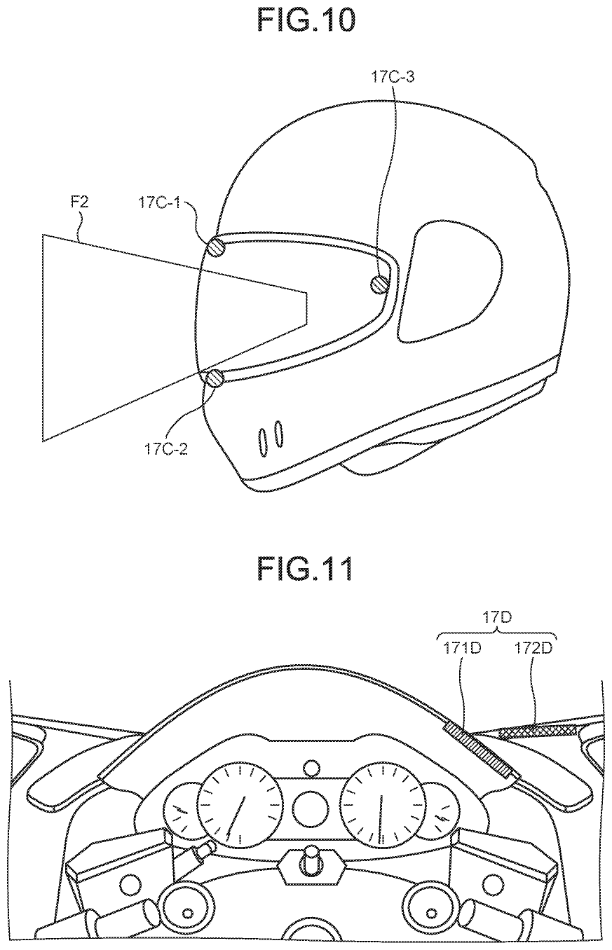

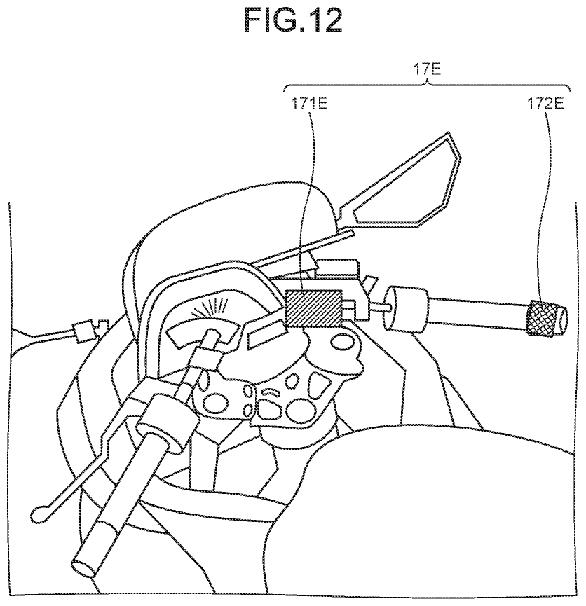

FIG. 11 is a view illustrating a schematic configuration of a display unit of the fifth modification example. As illustrated in FIG. 11, in a case where a moving body is a two-wheeled vehicle, a display unit 17D may include an LED tape 171D arranged on a left side (cowl portion) of a main body of the two-wheeled vehicle, and an LED tape 172D arranged on a right side (mirror stay portion) of the main body of the two-wheeled vehicle. In this case, the LED tape 171D may emit light similarly to the LED 171 of the first embodiment or the LED tape 171A of the second modification example, and the LED tape 172D may emit light similarly to the LED 172 of the first embodiment or the LED tape 172A of the second modification example.

### Sixth Modification Example

FIG. 12 is a view illustrating a schematic configuration of a display unit of the sixth modification example. As illustrated in FIG. 12, in a case where a moving body is a two-wheeled vehicle, a display unit 17E may include an LED tape 171E arranged on a left side (handlebar portion) of a main body of the two-wheeled vehicle, and an LED tape 172E arranged on a right side (handlebar end portion) of the main body of the two-wheeled vehicle. In this case, the LED tape 171E may emit light similarly to the LED 171 of the first embodiment or the LED tape 171A of the second modification example, and the LED tape 172E may emit light similarly to the LED 172 of the first embodiment or the LED tape 172A of the second modification example.

According to the present disclosure, operability of a moving body can be improved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A driving assistance device comprising:
a processor configured to
acquire moving body information indicating information of a moving body, and corner information indicating information of a corner of a road where the moving body travels, and
output assistance information that assists traveling of the moving body by controlling a light emission mode of a display unit located in a steering direction at the corner on a basis of the moving body information and the corner information.

2. The driving assistance device according to claim 1, wherein
the corner information includes map information and location information of the moving body.

3. The driving assistance device according to claim 2, wherein
the processor
specifies the corner where the moving body travels from the map information on a basis of the location information,
calculates a steering angle required when the moving body travels through the corner from the map information, and
outputs the assistance information that varies depending on the steering angle.

4. The driving assistance device according to claim 3, wherein
the processor
outputs the assistance information that calls more attention of a driver of the moving body as the steering angle becomes larger.

5. The driving assistance device according to claim 1, wherein
the processor
outputs characteristic information indicating a characteristic of the corner.

6. The driving assistance device according to claim 1, wherein
the assistance information is
information related to light that is output from the display unit to a driver of the moving body, and
information related to a color, a light emission frequency, or a light emission time according to the moving body information and the corner information, and
the processor outputs the assistance information to the display unit.

7. The driving assistance device according to claim 1, wherein
the processor
acquires a detection result of an eye gaze of a driver of the moving body,
determines a direction different from a direction of the eye gaze as a light emitting direction, and
sets the light emitting direction as a part of the assistance information.

8. A driving assistance system comprising:
display units that are arranged on right and left sides and that display assistance information to assist traveling of a moving body at a corner of a road; and
a processor configured to acquire moving body information indicating information of the moving body and corner information indicating information of the corner, and output the assistance information, which controls a light emission mode of the display unit located in a steering direction at the corner, to the display unit on a basis of the moving body information and the corner information.

9. The driving assistance system according to claim 8, wherein
each of the display units includes a light source that outputs the assistance information.

10. The driving assistance system according to claim 8, wherein
the corner information includes map information, and location information of the moving body, and
the processor
specifies the corner where the moving body travels from the map information on a basis of the location information,
calculates a steering angle required when the moving body travels through the corner from the map information, and
outputs the assistance information that varies depending on the steering angle to the display units.

11. The driving assistance system according to claim 10, wherein
the processor
outputs the assistance information that calls more attention of a driver of the moving body as the steering angle becomes larger.

12. The driving assistance system according to claim 8, wherein
characteristic information indicating a characteristic of the corner is output to the display units.

13. The driving assistance system according to claim 8, wherein
the assistance information is
information related to light output from the display units to a driver of the moving body, and
information related to a color, a light emission frequency, or a light emission time according to the moving body information and the corner information.

14. The driving assistance system according to claim 8, further comprising
an eye gaze sensor that outputs eye gaze information acquired by detection of an eye gaze of a driver of the moving body, wherein
each of the display units can change a light emitting direction, and
the processor acquires the eye gaze information from the eye gaze sensor,
determines, as the light emitting direction, a direction different from a direction of the eye gaze, and
outputs the light emitting direction to the display units as a part of the assistance information.

15. A non-transitory computer-readable recording medium storing a program for causing a processor to execute:
acquiring moving body information indicating information of a moving body and corner information indicating information of a corner of a road where the moving body travels; and
outputting assistance information that assists traveling of the moving body by controlling a light emission mode of a display unit located in a steering direction at the corner on a basis of the moving body information and the corner information.

16. The non-transitory computer-readable recording medium according to claim 15, wherein
the corner information includes map information, and location information of the moving body, and
the processor is caused to execute
specifying the corner where the moving body travels from the map information on a basis of the location information,
calculating a steering angle required when the moving body travels through the corner from the map information, and
outputting the assistance information that varies depending on the steering angle.

17. The non-transitory computer-readable recording medium according to claim 16, wherein
the processor is caused to execute
outputting the assistance information that calls more attention of a driver of the moving body as the steering angle becomes larger.

18. The non-transitory computer-readable recording medium according to claim 15, wherein
the processor is caused to execute
outputting characteristic information indicating a characteristic of the corner.

19. The non-transitory computer-readable recording medium according to claim 15, wherein
the assistance information is
information related to light that is output from the display unit to a driver of the moving body, and
information related to a color, a light emission frequency, or a light emission time according to the moving body information and the corner information, and
the processor is caused to output the support information to the display unit.

20. The non-transitory computer-readable recording medium according to claim 15, wherein
the processor is caused to execute
acquiring a detection result of an eye gaze of a driver of the moving body,
determining, as a light emitting direction, a direction different from a direction of the eye gaze, and
setting the light emitting direction as a part of the assistance information.
